(19) United States
(12) Patent Application Publication
(10) Pub. No.: US 2001/0046228 A1
(43) Pub. Date: Nov. 29, 2001

(54) METHOD AND ARRANGEMENT FOR INTERCONNECTING A VIRTUAL-REALITY WORLD AND THE REAL WORLD FOR THE PURPOSE OF ESTABLISHING A REAL-TIME COMMUNICATIONS CONNECTION SUCH AS A TELEPHONE CALL CONNECTION

(76) Inventors: JYRI TAHTINEN, HELSINKI (FI); KARI LEHTINEN, ESPOO (FI); RISTO LINTURI, HELSINKI (FI)

Correspondence Address: BIRCH STEWART KOLASCH AND BIRCH, P O BOX 747, FALLS CHURCH, VA, 220400747

(21) Appl. No.: 08/821,571

(22) Filed: Mar. 18, 1997

(30) Foreign Application Priority Data
Mar. 20, 1996 (FI) 961291

(51) Int. Cl. H04L 12/28

(52) U.S. Cl. 370/389

(57) ABSTRACT

The present invention relates to a method and arrangement for interconnecting a virtual-reality world (3) and the real world (7) for the purpose of establishing a real-time communications connection such as a telephone call connection. According to the method, a three-dimensional virtual-reality world (3) is formed. According to the invention, a subscriber of the real-world telephone network (7) is selected on the basis of a point in the coordinate space of the virtual-reality world (3), and the connection is established from the user (1) to the real-world telephone network subscriber (7) over the same communications channel as is used for establishing the connection toward the virtual-reality world (3).

The present invention relates to a method according to the preamble of claim 1 for interconnecting a virtual-reality world and the real world for the purpose of establishing a real-time communications connection such as a telephone call connection.

The invention also concerns an apparatus for linking a virtual-reality world with the real world.

So far virtual-reality techniques have chiefly been used in conjunction with computer games for creating a real-world-mimicking virtual-reality environment in which a player can move during a computer simulation.

The present invention is based on implementing the selection of a telephone network subscriber by means of an addressable point in the coordinate space of a given virtual-reality world, which in practice means that there exists a data structure in which the subscriber number information is associated with a certain point of the coordinate space of the virtual-reality world. Furthermore, the communications connection from the user of the virtual-reality world to a subscriber of the telephone network is established over the same communications channel as is used for establishing the connection toward the virtual-reality world (thus avoiding the disconnection of data communications connections for establishing a voice connection in the case of, e.g., a user operating over a modem/ISDN channel from home). For the purpose of establishing a bidirectional voice connection between the data communications network and the telephone network, the invention makes use of a conversion scheme applied between the digitally coded information of the data communications network and the coded voice signal of the telephone network.

More specifically, the method according to the invention is characterized by what is stated in the characterizing part of claim 1.

Furthermore, the arrangement according to the invention is characterized by what is stated in the characterizing part of claim 3.

The invention offers significant benefits.

By virtue of the virtual-reality interconnection scheme, call number selection is simplified and the novel technique also offers a natural way of establishing voice call and teleconferencing sessions. Furthermore, the same virtual-reality technique makes it possible to use future home terminal equipment for the purpose of subscribing to and using a plurality of other services, too.

In the following the invention is described in greater detail with the help of exemplifying embodiments by making reference to the appended drawing in which

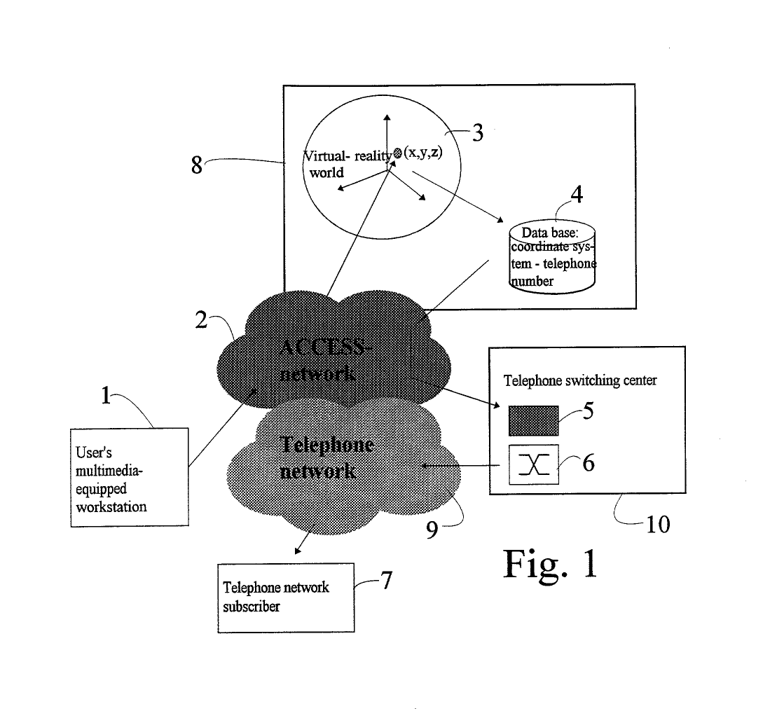

FIG. 1 shows diagrammatically the method according to the invention.

Referring to FIG. 1, the user establishes a connection from his/her multimedia-equipped workstation 1 (located, e.g., in home) via an access network 2 to a virtual-reality service 8. In the virtual-reality world 3, which may represent, e.g., a city modelled with streets and buildings, the user can navigate by means of the city map and/or three-dimensional coordinates.

By navigating to a desired point in the virtual-reality world 3, the user 1 can address, via coordinate points x,y,z of the three-dimensional virtual-reality world 3, the subscribers 7 of the real-world telephone network 9 associated with said coordinate points, thus establishing a voice connection to said subscribers if so desired. The voice connection is established by pointing a desired subscriber 7 of the telephone network 9 in the virtual-reality world 3 (analogously to hyperlinks in a hypertext document), whereby the server computer of the virtual-reality service 8 selects from its data base 4 the desired subscriber number of the telephone network 9 corresponding to the addressed virtual-world coordinate point. Then, a voice application is started on the user workstation 1 and the voice connection is formed in digitally-coded format superimposed on the data communications protocols over the same data communications channel 2 which is already being used for data communications so as to access a telephone switching center 10 where the required voice-signal conversions 5 of the data signal are performed and the call 6 is forwarded to the called subscriber 7 of the telephone network 9. When the called subscriber 7 of the telephone network 9 answers, the return channel is established via the switching center 10 (making the corresponding signal conversions) over the data communications channel on the basis of the calling party address in the access network.

The implementation techniques of the diagram parts are listed below in an exemplifying manner:

1. User workstation, multimedia accessories (sound card, videoconferencing set), data communications facilities (modem, ISDN, LAN, ATM).

2. Access network, which may comprise a telephone network (modem-accessible), an ISDN network, a local-access network or interconnected LANs (frame-relay) or a wide-band network (ATM).

3. The virtual-reality world may be implemented by means of a VRML (Virtual Reality Mark-up/Modelling Language) application in which the user can navigate using a browser. While this area of virtual-reality techniques is undergoing a strong phase of development, VRML is currently one of the most viable contenders in the field. The coordinates of the 3D world can be provided with hyperlinks associated with desired points or objects of the coordinate space.

4. The data base can be a tailored application for the use of the present invention, or alternatively, a distributed X.500 directory containing information on the hyperlink points of the coordinate space in the virtual-reality world and the corresponding addresses (telephone numbers) of the telephone/mobile phone/e-mail communications network.

5. Conversion of digitized voice for transmission over a telephone network takes place by means of a dedicated conversion system which is easiest to implement utilizing the sound cards of PC equipment. This function can be formed into an integral service of a telephone switching center (analogously to the trunking service between GSM and analog-signal telephone networks). An example of such an implementation is the LanPhone network offered by L.M. Ericsson Co.

6. Call routing to the telephone network subscriber is implemented in a conventional manner.

7. The telephone network subscriber receives the call in a conventional manner.

Another service provided by the virtual-reality world 3 is the location (tracing) of a mobile-phone subscriber in the coordinate space of the virtual-reality world. For instance, the location of a GSM subscriber can be inquired in the virtual-reality world 3 by the mobile-phone number of the subscriber, whereby the server computer traces the location of the GSM mobile phone from the home register of the mobile-phone network computer down to the location of the base station serving the phone. This information is returned to the inquiring party as coordinates of the virtual-reality world, or alternatively, he/she can be transferred in the virtual-reality world into the same “space” with the mobile-phone subscriber.

A third service provided by the virtual-reality world 3 is a conferencing session in a virtual meeting room for the subscribing parties. Such a virtual meeting can be participated in by users who have navigated in the virtual-reality world and into the meeting room by a voice connection or possibly using a video communications set; additionally, the conferencing session may be attended by subscribers of the real-world telephone network and/or teleconferencing system users.

Voice connection to real-world subscribers can be established in the manner described earlier, whereby also the conferencing phone services of switching centers can be utilized.

Not limited to real-time telephone connections, the above-described techniques further allow the virtual-reality world 3 to be used for establishing other types of real-time telecommunication connections such as telefax and data connections.

The connection between the subscribers of the virtual-reality world and the telephone network may also be established by displaying in the virtual-reality world (in the form of a virtual telephone directory) the telephone number of the called subscriber of the telephone network, after which the user can call the displayed number over the conventional telephone network. This form of connection requires a separate telephone channel and a data communications channel.

1. A method of interconnecting a virtual-reality world (3) and the real world (7) for the purpose of establishing a real-time communications connection such as a telephone call connection, in which method
a three-dimensional virtual-reality world (3) is formed, characterized in that
a telephone network subscriber (7) is selected on the basis of a point in the coordinate space of the virtual-reality world (3), and
the connection is established from the user (1) to the telephone network subscriber (7) over the same communications channel as is used for establishing the connection toward the virtual-reality world (3).

2. A method as defined in claim 1, characterized in that the virtual-reality world (3) is interconnected with the real world (7) by means of a data base (4) stored in the virtual-reality environment (3).

3. An arrangement for interconnecting a virtual-reality world (3) and the real world (7) for the purpose of establishing a real-time communications connection such as a telephone call connection, said arrangement comprising
means (1, 2, 3) for creating a virtual-reality world, characterized by
connection means (4) for linking the coordinate points (x,y,z) of the virtual-reality world with the coordinate points of the real world (7), and
conversion means (5) for converting the data format of the virtual-reality world into a compatible form with the data format of the real world (7).

4. An arrangement as defined in claim 3, characterized in that said connection means (4) is a data base (4) located in the virtual-reality environment (3).

5. An arrangement as defined in claim 3, characterized in that said conversion means (5) is a digital signal converter located in telephone switching center (10).
